(19) United States
(12) Patent Application Publication
(10) Pub. No.: US 2012/0232905 A1
(43) Pub. Date: Sep. 13, 2012

(54) METHODOLOGY TO IMPROVE FAILURE PREDICTION ACCURACY BY FUSING TEXTUAL DATA WITH RELIABILITY MODEL

(75) Inventors: Dnyanesh Rajpathak, Bangalore (IN); Soumen De, Bangalore (IN)

(73) Assignee: GM GLOBAL TECHNOLOGY OPERATIONS LLC, Detroit, MI (US)

(21) Appl. No.: 13/328,726

(22) Filed: Dec. 16, 2011

Related U.S. Application Data
(63) Continuation of application No. 13/045,310, filed on Mar. 10, 2011.

(51) Int. Cl. G10L 15/18

(52) U.S. Cl. 704/257; 704/E15.018

(57) ABSTRACT

A method and system for developing reliability models from unstructured text documents, such as text verbatim descriptions from service technicians. An ontology, or data model, and heuristic rules are used to identify and extract failure modes and parts from the text verbatim comments associated with specific labor codes from service events. Like-meaning but differently-worded terms are then merged using text similarity scoring techniques. The resultant failure modes are used to create enhanced reliability models, where component reliability is predicted in terms of individual failure modes instead of aggregated for the component. The enhanced reliability models provide improved reliability prediction for the component, and also provides insight into aspects of the component design which can be improved in the future.

### CROSS-REFERENCE TO RELATED APPLICATIONS

This application is a continuation-in-part application of U.S. patent application Ser. No. 13/045,310, filed Mar. 10, 2011, titled “DEVELOPING FAULT MODEL FROM UNSTRUCTURED TEXT DOCUMENTS”.

### BACKGROUND OF THE INVENTION

1. Field of the Invention

This invention relates generally to a method for developing reliability models and, more particularly, to a method for developing reliability models from unstructured text document sources, such as text verbatim descriptions from service technicians, which uses an ontology and heuristic rules to extract descriptive terms, including failure modes and parts, from the verbatim, merges like-meaning but differently-worded terms using text similarity scoring techniques, and uses the extracted failure modes to build more refined reliability models.

2. Discussion of the Related Art

Modern vehicles are complex electro-mechanical systems that employ many sub-systems, components, devices, sensors and control modules, which pass operating information between and among each other using sophisticated algorithms and data buses. As with anything, these types of devices and algorithms are susceptible to errors, failures and faults that can affect the operation of the vehicle. To help manage this complexity and estimate future warranty expenses, vehicle manufacturers develop reliability models. The reliability models predict the expected longevity of components and sub-systems or, more particularly, what percentage of a given component or sub-system can be expected to need repair or replacement at various increments of the vehicle's life.

Vehicle manufacturers commonly develop reliability models using “labor code” data from vehicle service visits. Labor codes represent work performed by service technicians, and are standardized to apply to any vehicle. Examples of labor codes include “front end alignment”, and “replace left front headlight”. While the labor code data provides an accurate indication of what work was performed, and what components or sub-systems were repaired or replaced, it does not provide a lot of insight into exactly what failure mode was experienced. For example, if a headlight had to be replaced, was the connector bad, or was the glass cracked, or did the bulb element burn out, or was there some other reason for the component replacement?

There is a need for reliability models which predict component reliability based on individual failure modes. Such an improved reliability model can not only predict overall component failure rates more accurately, but can also provide insight into the specific failure modes which need attention in future designs.

### SUMMARY OF THE INVENTION

In accordance with the teachings of the present invention, a method and system are disclosed for developing reliability models from unstructured text documents, such as text verbatim descriptions from service technicians. An ontology, or data model, and heuristic rules are used to identify and extract failure modes and parts from the text verbatim comments associated with specific labor codes from service events. Like-meaning but differently-worded terms are then merged using text similarity scoring techniques. The resultant failure modes are used to create an enhanced reliability model, where component reliability is predicted in terms of individual failure modes instead of aggregated for the component. The enhanced reliability model provides improved reliability prediction for the component, and also provides insight into aspects of the component design which can be improved in the future.

Additional features of the present invention will become apparent from the following description and appended claims, taken in conjunction with the accompanying drawings.

### BRIEF DESCRIPTION OF THE DRAWINGS

FIG. 1 is a schematic diagram of a system which takes unstructured text documents, automatically parses them using an appropriate process to produce a fault model, and uses the resultant fault model in both onboard and off-board systems;

FIG. 2 is a flow chart diagram of a method that can be used to develop fault models from unstructured documents, such as customer and service technician verbatim documents;

FIG. 3 is a flow chart diagram of a method for extracting descriptive terms, including parts, symptoms, and failure modes, from the unstructured verbatim documents;

FIG. 4 is a schematic diagram of a system which takes text verbatim data from service records, parses the text data to extract failure modes associated with each service event, and uses the failure modes to build an enhanced reliability model;

FIG. 5 is a flow chart diagram of a method for building enhanced reliability models using failure mode extraction through text mining; and

FIG. 6 is a flow chart diagram of a method for extracting failure modes from technician verbatim records for use in enhanced reliability models.

### DETAILED DESCRIPTION OF THE EMBODIMENTS

The following discussion of the embodiments of the invention directed to a method and system for developing reliability models from text documents is merely exemplary in nature, and is in no way intended to limit the invention or its applications or uses. For example, the present invention has particular application for vehicle reliability models. However, the invention is equally applicable to reliability models in other industries, such as aerospace and heavy equipment, and to failure prediction in any mechanical, electrical, or electro-mechanical system where reliability models are used.

Fault models and reliability models are tools commonly used by product manufacturers to help them improve product quality. New techniques in text data mining can be employed to develop improved fault models and reliability models. The improved models can be developed using automated techniques, and can provide increased insight into product quality and reliability.

Fault models have long been used by manufacturers of vehicles and other systems to document and understand the correlation between failure modes and associated symptoms. The failure mode and symptom data which is the basis of a fault model can be found in a variety of unstructured text verbatim, such as customer and dealer comments. But because unstructured text verbatim can be difficult and time-consuming to review for fault model content, many types of text verbatim have traditionally not been used to develop fault models for particular vehicles or systems, and thus manufacturers have not gained the benefit of all of the data contained in the unstructured text verbatim. The present invention provides a solution to this problem, by proposing a method and system for automatically developing fault models from unstructured text verbatim.

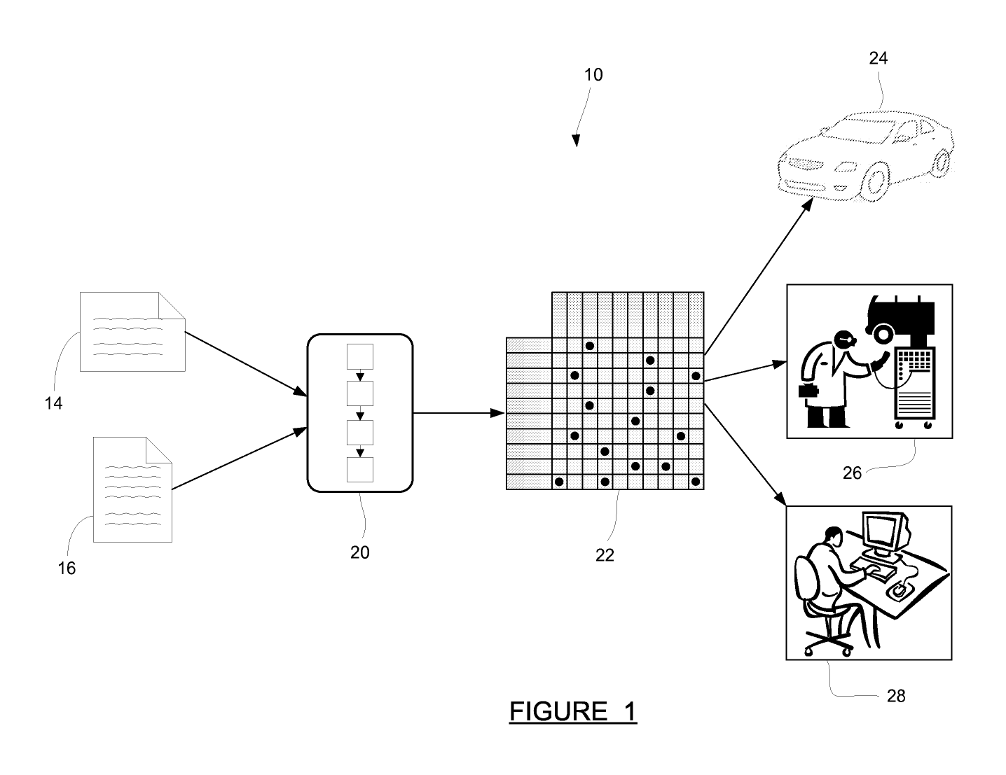

FIG. 1 is a schematic diagram of a system 10 which takes text document input, applies text-processing rules, parsing techniques, and other types of analysis to create a fault model, and uses the resultant fault model for diagnostic purposes, both onboard a vehicle and off-board. The system 10 is shown using a customer text verbatim 14 and service technician text verbatim 16 as input. Other types of unstructured text documents may also be used, but discussion of the verbatim 14 and 16 will be sufficient to explain the concepts involved in fault model development. The text verbatim 14 and 16 may include textual descriptions of symptoms exhibited by a vehicle and what was done to address the symptoms, both from customers and from technicians.

An unstructured text parsing module 20 can receive the text verbatim 14 and/or 16, and perform a set of parsing and analysis steps, described below, to produce the fault model 22. The fault model 22 contains a simplistic representation of the failure modes and symptoms described in the verbatim 14 and/or 16. As a digital database, the fault model 22 can be loaded into a processor onboard a vehicle 24 for real-time system monitoring, or used in a diagnostic tool 26 at a service facility. In the form of a database, the fault model 22 can also be used at a remote diagnostic center for real-time troubleshooting of vehicle problems. For example, vehicle symptom data and customer complaints could be sent via a telematics system to the remote diagnostic center, where a diagnostic reasoner could make a diagnosis using the fault model 22. Then a customer advisor could advise the driver of the vehicle 24 on the most appropriate course of action. As a printable document, the fault model 22 can be read by a technician servicing a vehicle, or used by vehicle development personnel 28 for creation of improved service procedure documents and new vehicle and system designs.

A simplistic representation of the fault model 22 is a two-dimensional matrix that contains failure modes as rows, symptoms as columns, and a correlation value in the intersection of each row and column. Part identification data is typically contained in the failure modes. The correlation value contained in the intersection of a row and a column is commonly known as a causality weight. In the simplest case, the causality weights all have a value of either 0 or 1, where a 0 indicates no correlation between a particular failure mode and a particular symptom, and a 1 indicates a direct correlation between a particular failure mode and a particular symptom. However, causality weight values between 0 and 1 can also be used, and indicate the level of strength of the correlation between a particular failure mode and a particular symptom. Causality weight values of 0 and 1 are often known as hard causalities or correlations, while causality weight values between 0 and 1 are described as soft. Where more than one failure mode is associated with a particular symptom or set of symptoms, this is known as an ambiguity group.

In a more complete form, the fault model 22 could include additional matrix dimensions containing information such as customer complaint codes, trouble codes, diagnostic trouble codes (DTCs), operating parameters (also known as Parameter IDentifiers, or PIDs), signals and actions, as they relate to the failure modes and symptoms. For clarity, however, the text document-based fault model development methodology will be described in terms of the two primary matrix dimensions, namely failure modes and symptoms, with part information included as appropriate.

FIG. 2 is a flow chart diagram 90 of a method that can be used in the unstructured text parsing module 20 to create the fault model 22 from the text verbatim 14 and 16. At box 92, the customer text verbatim 14, the service technician text verbatim 16, or both are provided. The customer text verbatim 14 and service technician text verbatim 16 are intended to contain a compilation of a fairly large number of text verbatim descriptions related to a particular fault in a particular vehicle or system. That is, the verbatim 14 and 16 cannot just contain one or a few incident descriptions, which would be insufficient to perform extraction and statistical analysis. The more text records provided in the verbatim 14 and 16, the better the resultant quality of the fault model 22 is likely to be.

At box 94, an ontology and heuristic rules are used to extract descriptive terms of interest from the customer and technician text verbatim descriptions. An ontology is an information model that explicitly describes various entities, the properties associated with the entities, and the relationship types along with abstractions that exists in a domain along with the properties. In the context of fault model development, an ontology is a model of the parts, failure modes, symptoms, and the relationships that exist between these entities. Furthermore, it also consists of other parameters expected to be found in a vehicle or system. For example, an engine that won't start may be related to a failure mode in the fuel system, but is likely not related to a failure mode in the navigation system. Heuristics denotes the application of a general rule or a rule of thumb for solving a problem, without the exhaustive application of an algorithm. In the context of fault model development from text verbatim descriptions, heuristic rules can be applied to sentences, for example, to distinguish between a period used in an abbreviation and a period used at the end of a sentence.

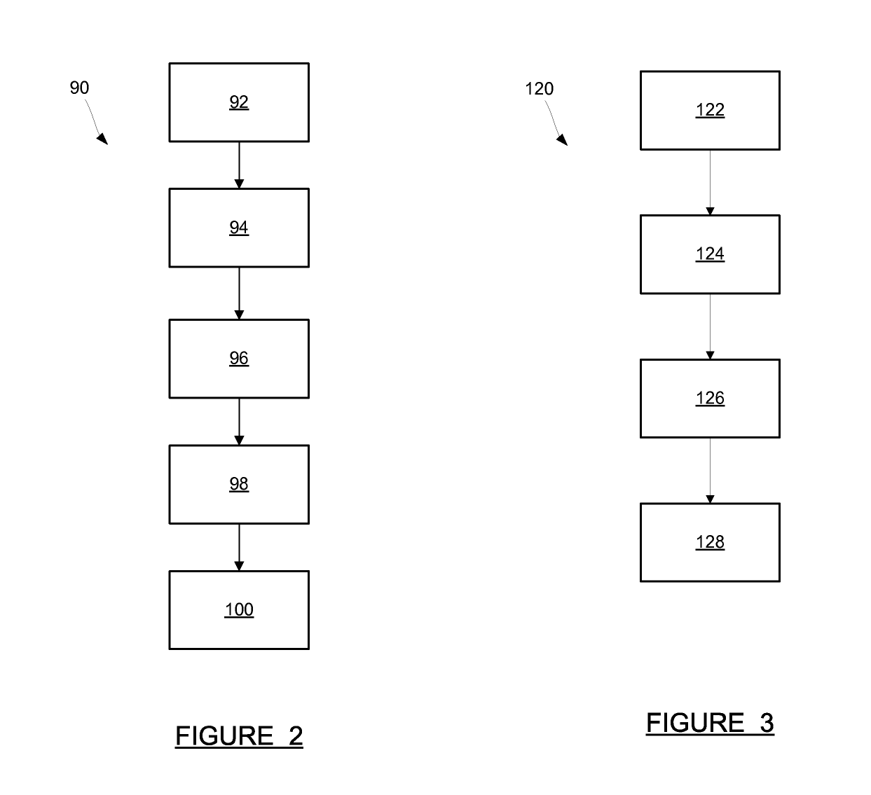

FIG. 3 is a flow chart diagram 120 of a method for extracting descriptive terms from the verbatim 14 and 16, which is applied at the box 94. At box 122, sentence boundaries are detected using heuristics and other rules. Sentence boundaries are detected by finding full stop punctuation, that is, a period, a colon or a semicolon. However, punctuation marks must be evaluated in the context in which they are used before being determined to be a sentence delimiter. For example, periods may be used in abbreviations and acronyms, as well as ellipses or at the end of sentences. Punctuation marks used in abbreviations and other non-sentence-ending contexts are ignored, and sentence boundaries are defined using the remaining full stop punctuation as delimiters. The sentence boundaries defined at the box 122 allow words and phrases, such as symptoms and failure modes, to be grouped together and properly associated, as will be seen in a later step. Any suitable methodology may be used to detect sentence boundaries. One example is described in U.S. patent application Ser. No. 13/044873, titled METHODOLOGY TO ESTABLISH TERM CO-RELATIONSHIP USING SENTENCE BOUNDARY DETECTION, filed Mar. 10, 2011, which is assigned to the assignee of this application and hereby incorporated by reference.

At box 124, unnecessary or superfluous words are removed, such as the articles “a”, “an”, and “the”. Other types of non-descriptive terms, and words such as “who”, “because”, and “becomes”, not relevant to fault model or reliability model development, may also be removed at the box 124. A list of non-descriptive terms can be maintained and used at the box 124. The ontology, or data model, described previously, can also be used to separate the useful descriptive terms from the unnecessary non-descriptive terms.

At box 126, parts, symptoms, and failure modes are identified in the sentence fragments. Diagnostic trouble codes (DTCs) are one commonly-seen type of symptom. However, non-DTC symptoms are also important, and are also identified at the box 126. Examples of non-DTC symptoms include “no cold air from NC system”, and “rattle in door”. The ontology is used to identify the parts, symptoms, and failure modes at the box 126. At this point, the text verbatim 14 and 16 have been reduced to a document corpus containing many sentence fragments, where each sentence fragment consists of only descriptive terms, such as parts, symptoms, and failure modes.

At box 128, a frequency analysis is performed, to determine which of the parts, symptoms, and failure modes are valid for inclusion in the fault model 22. For each sentence fragment in the document corpus, a focal term is identified, typically a part. Here again, the ontology is used to identify parts. Then a word window is established on either side of the focal term, where the word window could be, for example, three terms to the left and right of the focal term. From within the word window of each sentence fragment, pairs are formed between a part and either a symptom or a failure mode. That is, a pair is formed between a particular part and a particular symptom from one sentence fragment, a pair is formed between a particular part and a particular failure mode from another sentence fragment, and so forth. After all of the sentence fragments have been analyzed and all pairs formed, the total frequency of occurrence of each pair is computed. That is, the number of times that a particular symptom or failure mode co-occurs with a particular part is counted. If the frequency of occurrence for a particular pair, which may be the occurrence count for that pair divided by the total number of pairs in all of the sentence fragments, exceeds a certain minimum frequency threshold, then the pair is determined to be a valid pair. Again, each pair consists of a part and a descriptive term—either a symptom or a failure mode. The frequency calculation of the box 128 is used to ensure that only valid and significant descriptive terms are included in the fault model 22.

The frequency analysis at the box 128 is the final step in the process of extracting text at the box 94 of the flow chart diagram 90. The output of the box 94 is a complete set of valid descriptive terms from the text verbatim documents 14 and 16. The descriptive terms include symptoms, failure modes, and the related parts. At box 96, the descriptive terms from the box 94 are classified into types. In one embodiment of the method, parts are deleted from the set of descriptive terms, leaving just the symptoms and failure modes. However, deleting parts is not necessary, as the parts can be left in the set of descriptive terms, in which case the parts can be carried through to the completion of the process and included in the fault model 22.

The descriptive terms are to be classified as symptoms, failure modes, and optionally, parts at the box 128. It is helpful to sub-classify symptoms into DTC symptoms and non-DTC symptoms. DTC symptoms are normally readily identified by the presence of the DTC identifier, which will have a specific standard format of a letter followed by four digits. For example, “DTC P0451” is related to fuel tank pressure sensor problems. Thus, rules can be defined which make identifying DTC symptoms straightforward, even in data extracted from an unstructured document. Non-DTC symptoms and failure modes can be matched from the ontology described previously. After classification at the box 96, the descriptive terms have been separated into DTC symptoms, non-DTC symptoms, failure modes, and optionally, parts.

In order to further illustrate the concept of parts, symptoms (both DTC and non-DTC), failure modes, and the relationships therebetween, a specific example will be explored. In this example, the part being considered is a fuel tank pressure sensor, or FTP sensor. Non-DTC symptoms which may be related to an FTP sensor problem include; reduced engine power, engine cuts out, engine will not start, unusual fuel gauge readings, and others. In addition, DTC symptoms, including one or more specific DTC's being captured, may also be present. Failure modes associated with the FTP sensor include; FTP sensor short to ground, FTP sensor short to voltage, FTP sensor internal short, FTP sensor stuck, FTP sensor open circuit, and others. Correlations between these symptoms and these failure modes are established using the method described above. For example, the failure mode “FTP sensor short to voltage” may be correlated to several DTC and non-DTC symptoms with a causality weight of 1, whereas the failure mode “FTP sensor short to ground” may only correlate with a single symptom. The fuel tank pressure sensor example illustrates not only the complexity of fault diagnosis in a vehicle comprising thousands of components and sub-systems, but also the importance of a complete and accurate fault model.

Returning to the flow chart diagram 90—at box 98, various text similarity measures can be employed to merge phrases, or descriptive terms, which are similar and may in fact mean the same thing. For example, a failure mode may be written by a technician as “fuel tank pressure sensor shorted”, “FTP short circuit”, or “fuel pressure sensor short circuit”; these three text strings mean the same thing, and the quality of the fault model 22 will be better if each failure mode or symptom is only included once—not multiple times with slightly different wording. The text similarity measures can include lexical similarity, probabilistic similarity, and hybrid lexical/probabilistic approaches. Acronyms can also be resolved using the ontology. These text similarity measures are known in the art, and need not be discussed in detail here. Various algorithms exist which are based on these text similarity measures, each of which provides a similarity score for each pair of text strings. In this way, a similarity score can be computed between pairs of symptoms, failure modes, and parts.

The similarity score for each pair of text strings can be compared to a threshold value to determine if the two text strings can be considered a match. If the similarity score for any pair of text strings meets or exceeds the threshold value, then the two text strings are determined to be the same, and the preferred text string is selected for both. Text string pairs with a very low similarity score can be automatically determined to be different, while text string pairs with similarity scores near but below the threshold can be reviewed by a subject matter expert for a determination of whether the two text strings represent the same symptom, failure mode, or part. After phrase merging at the box 98, a rationalized set of descriptive terms remains—including DTC symptoms, non-DTC symptoms, failure modes, and optionally, parts.

At box 100, the fault model 22 is assembled from the failure modes and symptoms as classified at the box 96, with items merged as identified at the box 98. The relationships or correlations between failure modes and symptoms, needed for fault model creation, are obtained from the sentence and part associativity retained from the text extraction steps at the box 94. Using the techniques described above, unstructured text verbatim, such as the customer text verbatim 14 and the service technician text verbatim 16, can be parsed and analyzed by the unstructured text parsing module 20 to produce the fault model 22. The fault model 22 can then be used, for example, to perform real-time fault diagnosis in an onboard computer in the vehicle 24, to perform off-board fault diagnosis using the diagnostic tool 26 or at a remote diagnostic center, or used by the vehicle development personnel 28 for updating service documents or designing future vehicles, systems, or components.

The benefits of being able to develop fault models from text documents are numerous. One significant benefit is the ability to reliably create high-fidelity fault models from text documents with a minimal amount of human effort. Also, by limiting the human involvement to the review and disposition of a small number of borderline items, the opportunity for human error or oversight is greatly reduced. Another benefit of being able to develop the fault model 22 from text verbatim is the ability to capture valuable customer complaint data which otherwise would likely not be used in fault model development. This can be done readily, once the diagnostic rules and ontology are developed as described above.

Finally, the methods disclosed herein make it possible to discover and document hidden or overlooked correlations, thus improving the quality of the resultant fault model data. The fault model 22 is a powerful document which can enable a vehicle manufacturer to increase first time fix rate, enhance customer satisfaction, reduce warranty costs, and improve future product designs.

As discussed above, text mining and extraction techniques can also be employed to identify failure modes for use in reliability models. Reliability models are used by product manufacturers to predict statistical failure rates of components and systems as a function of exposure, where exposure could be time of the product in service or, in the case of a vehicle, number of miles on the vehicle. A number of reliability modeling techniques are known in the art, with Weibull being among the most common. In a Weibull reliability model, data on past failures of a component are used to compute a reliability function containing a shape parameter k and a scale parameter λ. The shape parameter k indicates whether failures are decreasing (k<1), increasing (k>1), or holding steady (k≈1) with time. The scale parameter λ indicates the overall magnitude of the failure rate. Once constructed, the Weibull reliability model can be used to predict the number of failures that would be expected from the component at a given exposure (number of days or miles).

While Weibull and other reliability models can suitably predict future failure rates based on past failure data, their accuracy is limited if the failure data with which the reliability models are built are aggregated too coarsely. This is often the case with automotive reliability models, where service event labor codes are used to represent failure modes. This is because a service labor code, such as “replace head lamp”, can cover several different component failure modes. It is desirable to use existing information about the service events to resolve labor codes into unique individual failure modes, and use the individual failure modes to construct improved reliability models.

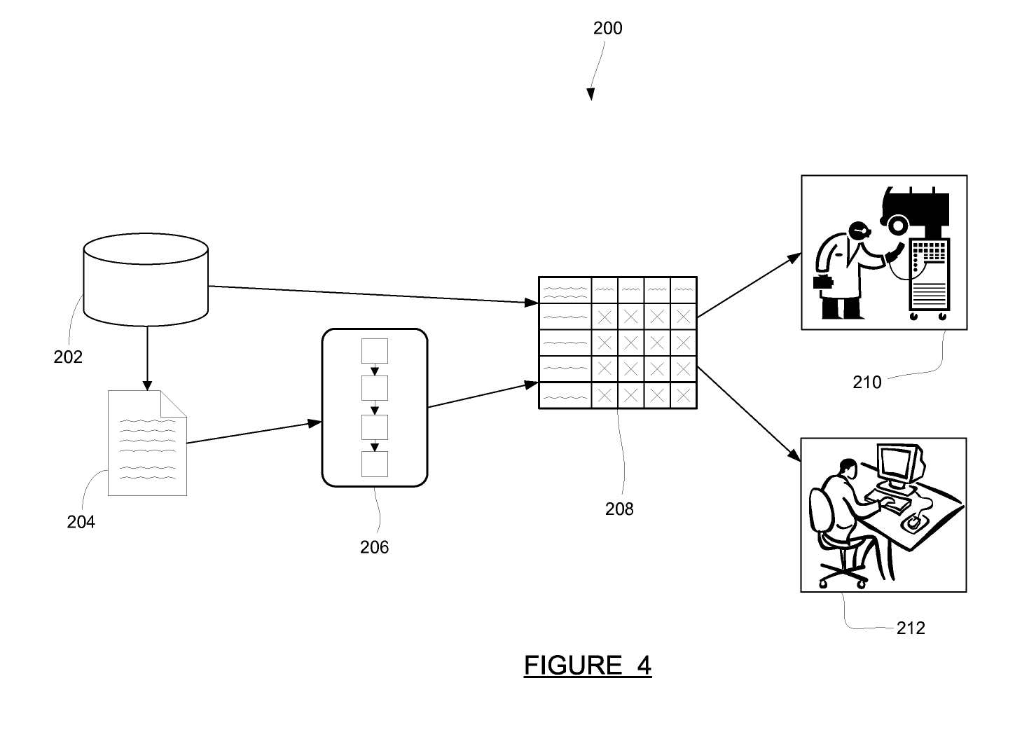

FIG. 4 is a schematic diagram of a system 200 which takes text verbatim data from service records, parses the text data to extract failure modes associated with each service event, and uses the failure modes to build an enhanced reliability model. A database 202 contains data about vehicle service events for many vehicles—for example, for an entire model line of a manufacturer. The database 202 may be known as a warranty database, a quality database, or a service database, among other possible names. The database 202 contains information including the date of each service event, the Vehicle Identification Number (VIN) of the vehicle which was serviced, the number of miles the vehicle had on its odometer at the time of service, the customer description of the problem or the reason for service, the labor codes associated with any work performed by the service technician, the part numbers of any parts replaced during service, and text comments by the service technician.

A service technician text verbatim document 204 can be exported from the database 202, containing the text of any notes recorded by the service technician during each service event. The document 204 can be parsed using a text extraction module 206, discussed below, to produce failure modes, which in turn are used, along with other data from the database 202, to create an enhanced reliability model 208. The enhanced reliability model 208 can actually be composed of multiple individual reliability models, one for each of the failure modes discovered. The enhanced reliability model 208 can be used by failure and warranty prediction personnel 210, and by vehicle development personnel 212 for creation of improved component and system designs. It is to be understood that the text extraction module 206 can be embodied in any suitable digital computing device which is encoded with the text mining techniques disclosed herein. Furthermore, the database 202, the document 204, and the reliability model 208 can reside on the same digital computing device or another computing device, memory device, etc.

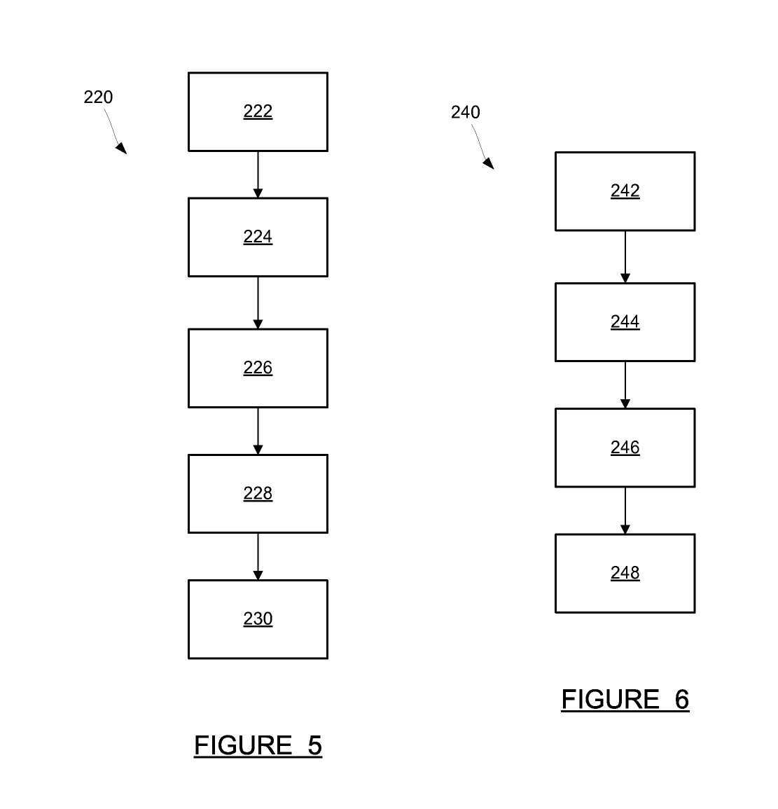

FIG. 5 is a flow chart diagram 220 of a method for building an enhanced reliability model using failure mode extraction through text mining. At box 222, labor codes are selected for analysis from the database 202. Expanding on an example described previously, a labor code for “replaced Fuel Tank Pressure (FTP) sensor” could be selected. At box 224, the service technician text verbatim records from all FTP sensor replacement events are exported from the database 202. The text verbatim records include technician comments, and may be useful for further diagnosing the problem. For example, the technician may run a diagnostic test which indicates a specific failure mode of the FTP sensor, and may record this in the database 202. Specific failure modes for the FTP sensor would include; FTP sensor short to ground, FTP sensor short to voltage, FTP sensor internal short, FTP sensor stuck, FTP sensor open circuit, and possibly others. However, the text verbatim records are by nature unstructured, and it is not a trivial matter to identify parts and failure modes from text records which are unformatted and may contain abbreviations, typographical errors, and other ambiguities.

At box 226, failure modes are extracted from the text verbatim records using text mining techniques. These techniques, including the ontology and heuristic rules, have been described in detail in the preceding discussion of fault model development, and will be reviewed again here for completeness. FIG. 6 is a flow chart diagram 240 of a method for extracting failure modes from technician verbatim records for use in enhanced reliability models. The flow chart diagram 240 details the activities of the box 226 from the flow chart diagram 220, and also represents the functions performed by the text extraction module 206 of the system 200. Each of the steps of the flow chart diagram 240 was described in detail in the discussion of FIGS. 2 and 3 above. At box 242, sentence boundaries are detected in the text verbatim records, using heuristic rules. Sentence boundary detection is important in order to properly associate a failure mode with a part. At box 244, superfluous or non-descriptive words are removed from the text verbatim records. Removing superfluous words allows for more efficient processing in subsequent steps.

At box 246, failure modes are found in the text verbatim records and extracted, by matching them to known failure modes in the ontology. At this point, the extracted failure modes may use different word strings to describe the same failure mode. For example, “FTP sensor open circuit”, “FTP sensor open”, and “FTP sensor O/C” all describe the same failure mode. At box 248, extracted failure modes are merged into common failure modes, using known shorthand and alternate descriptions from the ontology. The merged failure modes from the box 248 are then used as the basis for reliability model construction.

Returning to FIG. 5—using the text extraction techniques at the box 226, a single labor code, such as “replaced FTP sensor” can be resolved into several unique, contributing failure modes. At box 228, enhanced reliability models can be constructed using the individual failure modes instead of a blanket failure mode. In other words, instead of a single reliability model to predict the rate of occurrence of “FTP sensor failed”, several reliability models can be constructed, one for each of the specific FTP sensor failure modes mentioned above. Each failure mode-specific reliability model has its own shape parameter k and scale parameter A., and can be used at box 230 to predict the rate of occurrence of that specific failure mode at a given exposure.

The enhanced reliability models described above have two distinct advantages over traditional lumped-failure reliability models. First, the failure mode-specific reliability models have been shown to provide greater accuracy in predicting failure rates than reliability models based on aggregated labor code data. Second, the failure mode-specific reliability models provide insight into the exact failure underlying a given vehicle repair. The specific failure mode information can be used to redesign components and systems to address the biggest causes of reliability problems.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for creating reliability models for a component or system, said method comprising:
providing a text document containing technician comments about service events on the component or system;
extracting failure modes from the text document using a digital computing device encoded with text mining techniques; and
creating reliability models for the component or system using the failure modes which were extracted.

2. The method of claim 1 wherein providing a text document includes exporting the text document from a database of service events.

3. The method of claim 1 wherein extracting failure modes includes detecting sentence boundaries, removing non-descriptive words, identifying failure modes, and merging failure modes which are worded differently but have the same meaning.

4. The method of claim 3 wherein detecting sentence boundaries includes identifying full-stop punctuation marks, using the full-stop punctuation marks to define sentence boundaries, and defining correlations between the failure modes and parts based on the sentence boundaries.

5. The method of claim 3 wherein merging failure modes includes using text similarity techniques to assign a similarity score to a pair of failure modes, comparing the similarity score to a threshold value, and equating the pair of failure modes if the similarity score exceeds the threshold value.

6. The method of claim 1 wherein extracting failure modes includes using an ontology and heuristic rules.

7. The method of claim 6 wherein the ontology is a data model describing elements of the component or system, including parts, symptoms, and failure modes, and relationships between the parts, the symptoms, and the failure modes.

8. The method of claim 1 wherein creating reliability models for the component or system includes creating a separate reliability model for each of the failure modes which were extracted.

9. The method of claim 1 wherein the component or system is part of a vehicle.

10. The method of claim 1 wherein the reliability models are Weibull reliability models.

11. A method for creating reliability models for a vehicle sub-system or component, said method comprising:
providing a database containing information about vehicle service events;
exporting a text document from the database, said text document containing technician comments about the service events;
extracting failure modes from the text document using a digital computing device encoded with text mining techniques;
creating reliability models for the vehicle sub-system or component using the failure modes which were extracted, including a reliability model for each of the failure modes; and
using the reliability models to predict a number of failures of the vehicle sub-system or component at a given exposure.

12. The method of claim 11 wherein extracting failure modes includes detecting sentence boundaries, removing non-descriptive words, identifying failure modes, and merging failure modes which are worded differently but have the same meaning.

13. The method of claim 11 wherein extracting failure modes includes using an ontology and heuristic rules.

14. The method of claim 13 wherein the ontology is a data model describing elements of the vehicle sub-system or component, including parts, symptoms, and failure modes, and relationships between the parts, the symptoms, and the failure modes.

15. A system for creating reliability models for a vehicle sub-system or component, said system comprising:
means for providing a text document containing technician comments about service events on the vehicle sub-system or component;
a digital computing device encoded with text mining techniques for extracting failure modes from the text document; and
means for creating reliability models for the vehicle sub-system or component using the failure modes which were extracted.

16. The system of claim 15 wherein the text mining techniques for extracting failure modes include detecting sentence boundaries, removing non-descriptive words, identifying failure modes, and merging failure modes which are worded differently but have the same meaning.

17. The system of claim 16 wherein detecting sentence boundaries includes identifying full-stop punctuation marks, using the full-stop punctuation marks to define sentence boundaries, and defining correlations between the failure modes and parts based on the sentence boundaries.

18. The system of claim 16 wherein merging failure modes includes using text similarity techniques to assign a similarity score to a pair of failure modes, comparing the similarity score to a threshold value, and equating the pair of failure modes if the similarity score exceeds the threshold value.

19. The system of claim 15 wherein the text mining techniques for extracting failure modes include an ontology and heuristic rules, where the ontology is a data model describing elements of the vehicle sub-system or component, including parts, symptoms, and failure modes, and relationships between the parts, the symptoms, and the failure modes.

20. The system of claim 15 wherein the means for creating reliability models creates a separate reliability model for each of the failure modes which were extracted.
